(19) United States
(12) Patent Application Publication
(10) Pub. No.: US 2005/0157948 A1
(43) Pub. Date: Jul. 21, 2005

(54) Video resolution control for a web browser and video display

(75) Inventor: Janghwan Lee, Carmel, IN (US)

Correspondence Address: THOMSON LICENSING INC., PATENT OPERATIONS, PO BOX 5312, PRINCETON, NJ, 08543-5312, US

(73) Assignee: Thomson Licensing S.A., F - 92100 Boulogne-Billancourt (FR)

(21) Appl. No.: 10/512,360

(22) PCT Filed: Feb. 27, 2003
(86) PCT No.: PCT/US03/06202

Related U.S. Application Data
(60) Provisional application No. 60/375,503, filed on Apr. 25, 2002.

(51) Int. Cl. G06K 9/32; G09G 5/02; G06K 9/40; G09G 5/00

(52) U.S. Cl. 382/299; 345/698; 345/3.3; 382/298; 382/254

(57) ABSTRACT

A display device includes a video screen having a maximum resolution. An operating system generates a browser mode on the screen at the maximum resolution to aid in the user's ability to view text in a browser window. A video driver locates and sizes the browser window in accordance with the maximum resolution of the video screen to permit the browser window to be sized at the maximum resolution on the video screen.

### FIELD OF THE INVENTION

The present invention generally relates to graphical user interface technology and, more particularly, to a method and system for providing resolution control for display of multiple windows on a display screen, such as a television.

### BACKGROUND OF THE INVENTION

As network technologies have progressed, on-line video applications have been become more utilized. Many web sites and multimedia resources, available through a communications network as the Internet, provide video clips or live video feeds as a service for users. Videos and streaming content are now readily displayed on a user's a display screen or on a television screen. With devices that typically display images in a selected resolution, such as a television set, the resolution of a displayed image may not be the most desirable or may not be compatible with the selected screen resolution, which is pre-defined by the physical or software limits of a device. More specifically, video displayed in a pre-selected resolution may appear to be distorted.

Television sets now often include web-browsing capabilities. These television sets provide interactivity beyond just channels and volume selections, as users are able to receive content through an Internet connection. One drawback of employing a television set as a web browser display is that the display screen is often inadequate in resolution to permit text to be legible, for video is typically concurrently displayed with a web browser. Characters and other symbols displayed may be difficult to read in the web browser window because the resolution of the web browser is too low for legibly displaying text.

Therefore, a need exists for providing the highest possible resolution for television web-browsers when a display device is capable of multiple resolutions. A further need exists for a system which sizes and positions web-browser and video windows utilizing the best available screen resolution.

### SUMMARY OF THE INVENTION

A display includes a video screen having a capability for multiple resolutions, including a maximum resolution. An operating system generates a browser mode on the screen at the maximum resolution to aid in the user's ability to view text in a browser window. A video driver locates and sizes the browser window in accordance with the maximum resolution of the video screen to permit the browser window to be a largest size on the video screen.

A method for starting a web browser for use on a television screen includes initiating a browser mode of the television screen and changing the screen resolution of a browser window to its largest value to display the browser window at a largest possible size in accordance with the value. A position for the browser window is then determined on the television screen.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a system diagram illustratively showing a browser and video window resolution control components in accordance with the present invention;

FIG. 2 is a system diagram showing browser and video windows in accordance with the present invention;

FIG. 3 is a system diagram showing a browser-only mode in accordance with the present invention;

FIG. 4 is a system diagram showing a browser and video windows fit in a non-overlapping configuration in accordance with the present invention; and

FIG. 5 is a block diagram for implementing resolution control of a browser application in accordance with the present invention.

### DETAILED DESCRIPTION OF THE INVENTION

The present invention provides a method and system, which selects a maximum available screen resolution which will result in the largest video window or browser window size. In one embodiment, when a web-browser application mode is run on a television set display, the present invention selects a maximum screen resolution mode for setting the largest browser window. In addition, the appropriate screen resolution according to a television input source may be selected whenever leaving web browser mode. Video sources include information for their own resolution (or source format). The present invention may select the screen resolution according to video input source format (resolution). However, when a browser is displayed as a main window and video as a smaller window, the present invention permits a preferred screen resolution to be selected for the browser window, preferably, the maximum resolution screen for getting the most window area size for the browser.

It is to be understood that the present invention is described in terms of a television system; however, the present invention is much broader and may include any digital multimedia devices, which are capable of displaying video. In addition, the present invention is applicable to any input method including data received by telephone, set top boxes, computer, satellite links, etc. It should also be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

Video data or video content, for purposes of the application, signifies any type of data that may be rendered as video, on a display device. Typically such data is rendered in a window of a specific area, such as area is defined as the resolution of the window. The terms also referring to resolution, for this application, include screen resolution, display resolution, and window resolution, referring to the area of pixels occupied by video. Web browsers typically render video comprising of HTML data and/or other forms of hypertext languages. Optionally, such web browsers render video that are stored as files on a display device or as streaming media located from various sources from the Internet, or other type of communications network.

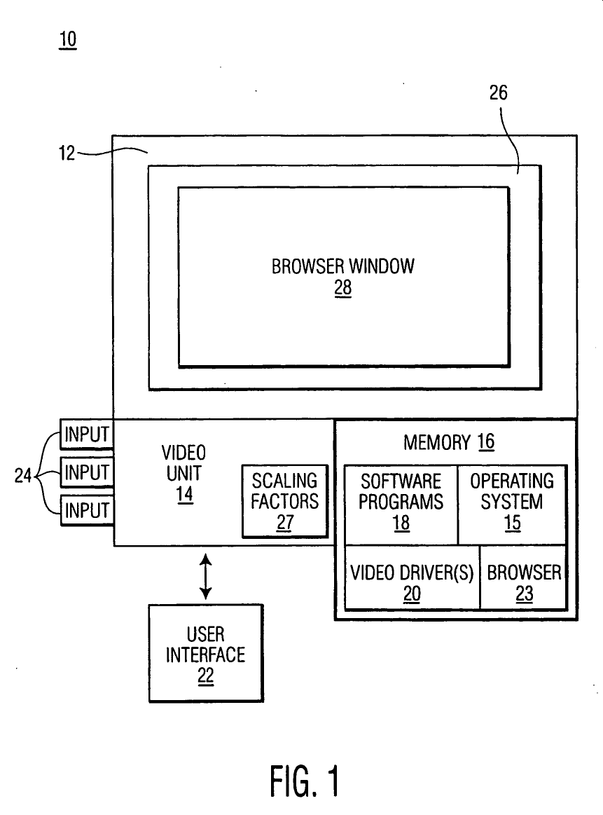

Referring now in specific detail to the drawings in which like reference numerals identify similar or identical elements throughout the several views, and initially to FIG. 1, an illustrative television system 10 is shown in accordance with one embodiment of the present invention. System 10, although shown as a television based system, represents any type of display device that is capable of accommodating different display resolutions. System 10 includes a television 12, which may include a digital screen, a liquid crystal display, a phosphor screen a plasma display screen or any other suitable technology screen. Television 12 preferably includes one or more electronic components, as is known in the art. Television 12 preferably includes a video processing unit (e.g., video card) 14, which has memory 16. Memory 16 includes one or more software components 18 stored therein. Video drivers 20 and supporting software are employed to implement the present invention, determine video window attributes, and to render video data. Video rendering drivers 20 (the plural form of the term, not being limiting) are typically implemented as software code comprising video information telling a video unit 14 how to render video data. Television 12 includes a user interface 22 which may be programmed and interacts with the user to provide user selected services or to permit the user to change system parameters, such as volume, channel, tint, contrast, etc. Interface 22 may include a wireless or a wired link between a remote or box and the television 12.

Television 12 includes one or more inputs port 24, such as RCA jacks, I-1394 ports, coaxial cable, fiber optic connections, USB port, etc., capable of to receiving video data. Inputs port 24 may receive data from cable, telephone, wireless broadband, satellite, a wireless network, such as a television network, the Internet, or any other data source that are capable of being rendered as a video image. Video card 14 receives input data and renders an image on a screen 26 of television 12. Typical resolutions for the rendering of video images are designated in accordance with ATSC video standard, such as 480p, 480i, 720p and 1080i, although other video resolutions may be used, as needed.

Television operations and window sizing are preferably implemented and controlled by an operating system 15. Operating system 15 may include any known operating system and can be stored in memory 16.

In one embodiment, a user enables a web-browser application (browser) 23. In accordance with the present invention, video processing unit 14 employs a video driver 20, which automatically sizes the web-browser window in accordance with the largest resolution available or a predetermined resolution if desired. Scaling factors 27 are video effects based processes for expanding and or contracting windows for use by video processing unit 14 and video driver 20. Scaling factors 27 are implemented as similar to video effects used for video editing, and other types of video window manipulation. Specifically, the web-browser window is appropriately sized to accommodate the selected resolution. In a preferred embodiment, the screen resolution of the web-browser window is sized in accordance with the largest available resolution. A maximum screen resolution may be, for example, 1280×1080 (pixels) for a 1080i based video data. The screen resolution may be defined by the data input, the video processing unit software or the pixel density of the screen, among other things. In this way, web-browser window 28 provides legible text to a user, without having the user manually re-size the browser window. Video driver 20 determines the size for the window for the browser in accordance with a highest available resolution for the television or the pre-selected screen resolution defined by a user.

In addition, when switching back to regular viewing mode, video processing unit 14 further provides for sizing of a viewing window for the best picture quality in accordance with the highest resolution available for the television 12. When the user selects a different mode, the present invention provides a determination of the best size and placement of the graphics windows to be placed on the screen. The present invention may account for the placement of one or more windows on a screen by determining a priority of the window. For example, if a user triggers a browser mode, a browser window will open which has the largest possible size in accordance with the best possible resolution capability of the system.

Continuing the example, a picture in a picture (PIP) screen is then opened, a largest possible window in accordance with the best possible resolution is shown, but the two windows are then placed in accordance with a predetermined or user-selected configuration. This may include an overlap of the windows with the last selected window in the foreground or include a split screen with no overlap. In any event, the size and placement of the windows will be in accordance with providing the best possible resolution for that configuration.

In addition, the type of windows to be displayed may further prioritize the resolution and use of the available space in a display screen. Since text in the browser mode may be difficult to decipher, the web browser or other textual content window may have priority over video screens. This may mean that screen space is utilized first for providing the best resolution for textual content screens before accommodating video screens. The window resolution setting may also be selected by the user to accommodate user preferences.

The present invention accommodates different onscreen graphics displays (OSDs) and PIP video size and position information for different screen resolutions. Sometimes, screen resolution is not enough to display all information on one screen so reductions in resolution may needed to be determined to fit the image of images on a single screen. In these instances, the largest possible resolution is adjusted to accommodate the largest possible resolution on a single screen.

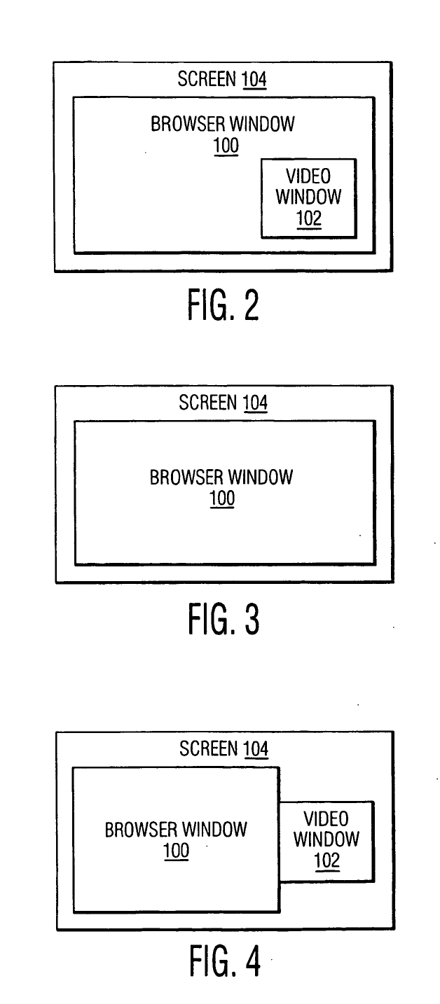

Referring to FIGS. 2, 3 and 4, diagrams are shown in accordance with illustrative screen shots in accordance with the present invention. Screen resolution control is provided by the present invention for displaying a web browser screen or screens and/or PIP video on a TV. When changing to web browser mode, the maximum screen resolution for getting the biggest web browser window size is preferably employed. When changing back to TV watching mode, the screen resolution is preferably changed to what is best fit to the input source. The examples shown in FIGS. 2-4 illustratively depict displaying a web browser 100 and a video window 102 simultaneously on a TV screen 104. In FIGS. 2-4, the maximum resolution may be 1920×1080, and the browser 100 size will be adjusted to 1920×1080. Video window 102 video resolutions selected within this size, but can also be adjusted by the window size (by, e.g., adjusting a scaling factor 27). Other resolutions and window sizes are also contemplated.

In FIG. 2, web browser 100 occupies the largest possible screen area (largest possible resolution) while video window 102 includes a resolution that is comparable to its input source. Video window 102 may also include the same video resolution as web browser 100.

FIG. 4 includes web browser 100 and video window 102 positioned to effectively provide the largest resolution given the screen area without overlapping, on screen 104. FIG. 3 shows a browser only screen 100 taking up all the area for screen 104. In accordance with the present invention, video drivers may be employed to permit a user the option to toggle between the browser only screen (FIG. 3) and a video window/browser screen (FIG. 4). Other display combinations and windows may also be sized and positioned in accordance with the present invention.

An additional embodiment of the invention supports the concept of having the invention support two sources of displayed content, one window being video of a specific resolution (102) and the other window being a web browser (100). In this embodiment, video window 102 has an intended resolution that is less than the maximum resolution capable of being displayed by television 12. If a user activates a browser resulting in the rendering of browser window 100, television 12 switches to the maximum screen resolution supported. Television 12 then will render the video in a window 102 of the intended video resolution and web browser, via browser window 100, will be rendered in the remaining area that is not occupied by the other video window 102 (see FIG. 4).

Optionally, television 12 does a check to determine if the text in browser window 100 is capable of being displayed legibly. For example, television 12 supports a maximum screen resolution of 1200×1080 pixels. In the present case, video window 102 needs to be displayed in an area of 720×576 pixels. Video drivers 20 perform a check to determine whether browser window 100 can be displayed with legible text, at the same time with video window 102. In the present case, a minimum size of a browser window 100 is defined for displaying legible text, as determined by the video drivers 20. For this example, it is pre-determined that browser window 28 has to support a minimal window area of 640×480 pixels, although any minimal area can be used (720×480, 720×576, 720×480, etc.), as predefined in the programming of the video drivers. Alternatively, video drivers 20 determine a minimize size for fonts to be displayed in browser window 100, so the window display fonts in a minimum point size, as determined in the programming of video drivers 20.

Video drivers 20 end up giving priority to browser window 100 by rendering a window in the minimum area space (640×480 pixels). Video window 102 is then reduced by a scaling factor that keeps the original aspect ratio of video content to be shown in the video window 102. The aspect ratios typically are 16:9, 4:3, 5:4, and other ratios. In this case, video window 102 is scaled down to 480×384 pixels (an ratio respecting the original aspect ratio of 1.25) by video drivers 20. This calculation is performed by video drivers 20 determining the maximum screen resolution of a device (1200×1080), by subtracting the requirements for the minimum window size required for browser window 100 (1200−720=480 pixels, horizontal direction, although the vertical direction may also be used). With the determined remainder (480 pixels), video drivers 20, optionally then scales video window 102 in accordance with the original aspect ratio of the displayed video. Optionally, video drivers 20 use scaling factors 27 to perform the operation listed above via use of video unit 14.

This embodiment may also be performed for systems requiring multiple windows. Depending upon the physical limitations of a display device, this embodiment may be modified to support two or more windows of video 102 and a browser window 100. Video windows or browser windows may be sized by employing scaling factors in the video drivers and re-computing the images in accordance with the appropriate scaling factors as determined by video drivers 20.

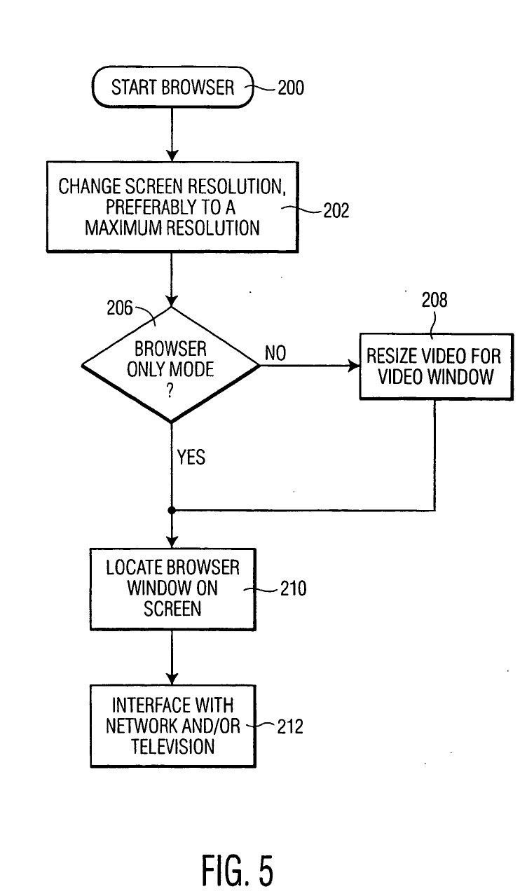

Referring to FIG. 5, (please refer to FIGS. 1-4 for reference numerals) a flow diagram is shown for starting a web browser and sizing and positioning browser 100 and video windows 102 in accordance with an illustrative embodiment of the present invention. In block 200, a user initiates a web browser application that is rendered on a display device, as television set 12. Web browser window 100 may be initiated automatically depending on user-selected settings for television 12. In block 202, screen resolution for television 12 is preferably set to its maximum value based on the capabilities and settings of television 12. For example, if television 12 is capable of 1080i resolution, the browser window will occupy the largest amount of screen area afforded by this screen resolution. This is preferably performed by video drivers 20 loaded on and executed by an operating system within television 12 or a display device.

Once the resolution has been determined, the web browser window 102 is located on the screen and rendered at a full screen size, occupying the full area of television screen 104. In block 206, a determination is made whether the last saved mode was a browser only mode. In block 208, if the last saved mode was browser only then browser window 100 is located and sized to fill screen 104. Locating web browser window 100 preferably includes deciding the web browser 100 size and position and video window 102 size and position if it is a web browser with an embedded video window.

In block 210, if the last saved mode was a combination of windows or other then browser only mode, then the screen locations of the windows are resized and located in accordance with the best viewing resolution possible or in accordance with user preferences. For example, if a video window 102 and a browser window 100 are simultaneously being displayed, a configuration such as that shown in FIG. 4 may be displayed. The resizing of the video for a video window 102 may include re-computing of video scaling factor in the video driver(s) for displaying video as a scaled video in the video window. This may be performed iteratively or based on conditional criteria. If, for example, it is desired to change the video window size, a scaling factor is resized for a video window. For example, if a reduction in the horizontal video size of 1/10 is needed, then a scaling factor of 1/10 is used. The scaling factor can be recomputed to obtain the best or better window size for an on-screen window or browser. In block 212, the web browser window 100 is employed as a user interface to navigate through a network such as, e.g., the Internet.

Having described preferred embodiments for resolution control for browser and video display (which are intended to be illustrative and not limiting), it is noted that modifications and variations can be made to utilize not just web browser windows, but any type of window where video is rendered. Such modifications may be done, in accordance with the principles of the present invention.

1. A display device comprising:
a display of area having a maximum resolution;
an operating system that generates a browser mode;
a video driver, which locates and sizes a browser window in accordance with the maximum resolution of the video screen to permit the browser window to be a largest size on the video screen.

2. The display as recited in claim 1, further comprising a video mode wherein at least one video window is generated concurrently with the browser window.

3. The display as recited in claim 1, wherein the display device is a television.

4. The display as recited in claim 1, further comprising a toggle feature, which permits switching between a browser window mode and a video window and browser window mode.

5. The display as recited in claim 1, wherein the video driver includes scaling factors, which alter the resolution of a video window when the browser window is opened.

6. The display as recited in claim 1, wherein the browser window is displayed at the maximum resolution without regard to a resolution of an input source of the display.

7. A method for starting a web browser for use on a television screen, comprising the steps of:
initiating a browser mode of the television screen;
changing the screen resolution to for a browser window to a largest value to display the browser window at a largest size in accordance with the value; and
locating a position for the browser window on the television screen.

8. The method as recited in claim 7, wherein the step of changing the screen resolution to a value includes changing the screen resolution to a largest possible value available to fit the television screen.

9. The method as recited in claim 7, further comprising the steps of providing at least one video window and resizing the video window in accordance with the value.

10. The method as recited in claim 9, wherein the resizing includes employing scaling factors to change the resolution.

11. The method as recited in claim 7, further comprising the step of toggling between a browser only mode and a video and browser mode.

12. The method as recited in claim 7, wherein the browser includes a web browser and the method further comprises the step of interacting with a network by employing the web browser.

13. The method as recited in claim 7, wherein the resizing includes positioning one or more windows on the screen in accordance with a window priority.

14. The method as recited in claim 7, wherein the priority is user-defined.

15. A display device comprising:
a display of area having an area of pixels;
an operating system that generates a browser window (28) and a video window with video content of an aspect ratio;
video rendering driver, wherein
said video driver, in response to a user selection, resizes video window as to accommodate a minimum size for browser window 28; and
said resized video window occupies a remainder of said area of pixels, maintaining said aspect ratio, as to render resized video window and browser window at the same time.

16. The display device of claim 15, wherein said video driver accommodates a second window of video that is resized, as to maintain said minimum size of browser window 28, wherein said second window maintains an aspect ratio for video content to be rendered in said second window.
